(19) United States
(12) Patent Application Publication
(10) Pub. No.: US 2010/0124312 A1
(43) Pub. Date: May 20, 2010

(54) Tomographic image capturing apparatus

(75) Inventors: Jun Enomoto, Kanagawa-ken (JP); Hirofumi Sawada, Minami-ashigara-shi (JP); Sadato Akahori, Odawara-shi (JP); Eiichi Kanagawa, Minami-ashigara-shi (JP); Tomoyoshi Nishimura, Tokyo (JP); Yasunori Ohta, Yokohama-shi (JP); Noriaki Ida, Minami-ashigara-shi (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/591,195

(22) Filed: Nov. 12, 2009

(30) Foreign Application Priority Data
Nov. 17, 2008 (JP) 2008-293269

(51) Int. Cl. H05G 1/60

(52) U.S. Cl. 378/21

(57) ABSTRACT

A tomographic image capturing apparatus includes a radiation source movable along a predetermined path, for applying radiation to a subject at different angles, a dose adjuster for adjusting the radiation source to make constant the dose of the radiation emitted from the radiation source independently of irradiation angles of the radiation with respect to the subject, a radiation detector for detecting the radiation transmitted through the subject while the radiation source moves along the predetermined path and converting the detected radiation into radiographic image information, and a tomographic image generator for generating a tomographic image of the subject based on the radiographic image information converted from the radiation detected by the radiation detector.

### CROSS-REFERENCE TO RELATED APPLICATION

This application is based upon and claims the benefit of priority from Patent Application No. 2008-293269 filed on Nov. 17, 2008, in the Japan Patent Office, of which the contents are incorporated herein by reference.

### BACKGROUND OF THE INVENTION

1. Field of the Invention

The present invention relates to a tomographic image capturing apparatus for capturing a tomographic image of a subject using a radiation source.

2. Description of the Related Art

Primarily in the field of medicine, tomographic image capturing apparatus have been used for producing tomographic images of a subject such as a patient by applying radiation to the subject at different angles, so as to obtain different items of radiographic image information, and thereafter processing the items of radiographic image information. The tomographic image capturing apparatus may include a CT (Computerized Tomography) apparatus and a tomosynthesis apparatus, which are known in the art.

The CT apparatus includes a radiation source and a 25′ radiation detector, which are disposed in confronting relation to each other. In operation, while the radiation source and the radiation detector revolve around the subject to be imaged, the radiation source emits radiation, and the radiation detector detects radiation that has passed through the subject. Radiographic image information, which is generated based on the radiation detected by the radiation detector, is processed in order to produce a tomographic image of the subject, along a plane in which the radiation source and the radiation detector revolve. The tomosynthesis apparatus also has a radiation source and a radiation detector, which are disposed in confronting relation to each other. In operation, while the radiation source and the radiation detector move relatively along a subject to be imaged, the radiation source emits radiation, and the radiation detector detects radiation that has passed through the subject. A tomographic image of the subject, which has been taken along the direction in which the radiation source and the radiation detector move, is generated based on radiation detected by the radiation detector (See, Japanese Laid-Open Patent Publication No. 2005-305113). In this case, the CT apparatus tends to be large and costly due to the fact that the radiation source and the radiation detector must revolve around the subject. A tomosynthesis apparatus is more compact and less expensive than a CT apparatus, because the radiation source and the radiation detector move within a smaller range, due to the limited angle within which radiation is applied.

Incidentally, with a tomosynthesis apparatus, because the radiation source and the radiation detector are moved relatively to one another, the incident angle of radiation that is irradiated toward the radiation detector differs depending on the positions. In this case, it is known that the amount (dose) of radiation emitted from the radiation source is subject to change, depending on the incident angle (or as viewed from the radiation source, the irradiation angle) of the radiation (“heel effect”). (See, Japanese Laid-Open Patent Publication No. 2007-259932.)

In a tomosynthesis apparatus, when radiation image information is acquired and a tomographic image is generated without taking into consideration the influence of the heel effect, an unsuitable tomographic image may result due to so-called shading.

### SUMMARY OF THE INVENTION

The present invention is made to eliminate the aforementioned defects, and an object of the present invention is to provide a tomographic image capturing apparatus, which is capable of generating a high quality tomographic image devoid of shading.

According to the present invention, there is provided a tomographic image capturing apparatus comprising a radiation source movable along a predetermined path, for applying radiation to a subject at different angles, a dose adjuster for adjusting the radiation source to make constant the dose of radiation emitted from the radiation source independently of irradiation angles of the radiation with respect to the subject, a radiation detector for detecting radiation transmitted through the subject while the radiation source moves along the predetermined path, and converting the detected radiation into radiographic image information, and a tomographic image generator for generating a tomographic image of the subject based on the radiographic image information converted from the radiation detected by the radiation detector.

In addition, according to the present invention, there also is provided a tomographic image capturing apparatus comprising a radiation source movable along a predetermined path, for applying radiation to a subject at different angles, a radiation detector for detecting the radiation transmitted through the subject while the radiation source moves along the predetermined path, and converting the detected radiation into radiographic image information, an image corrector for correcting the radiographic image information into radiographic image information that should be acquired when the dose of the radiation emitted from the radiation source is made constant independently of irradiation angles of the radiation with respect to the subject, and a tomographic image generator for generating a tomographic image of the subject based on the radiographic image information which has been corrected by the image corrector.

The tomographic image capturing apparatus of the present invention adjusts the radiation source so as to make the dose of radiation emitted from the radiation source constant independently of irradiation angles of the radiation with respect to the radiation detector, or alternatively, corrects the radiographic image information detected by the radiation detector into radiographic image information that should be acquired when the radiation dose is made constant independently of the irradiation angles of the radiation with respect to the radiation detector. Consequently, a high quality tomographic image can be generated, which is devoid of shading caused by the irradiation angle.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a schematic view, partially in block form, showing a tomosynthesis apparatus, which forms a tomographic image capturing apparatus according to a first embodiment of the present invention;

FIG. 2 is a schematic view, partially in block form, showing a tomosynthesis apparatus, which forms a tomographic image capturing apparatus according to a second embodiment of the present invention; and

FIG. 3 is an explanatory drawing showing another mode concerning movement directions of the radiation sources that make up the tomosynthesis apparatus.

### DESCRIPTION OF THE PREFERRED EMBODIMENTS

Like or corresponding parts are denoted by like or corresponding reference characters throughout the views.

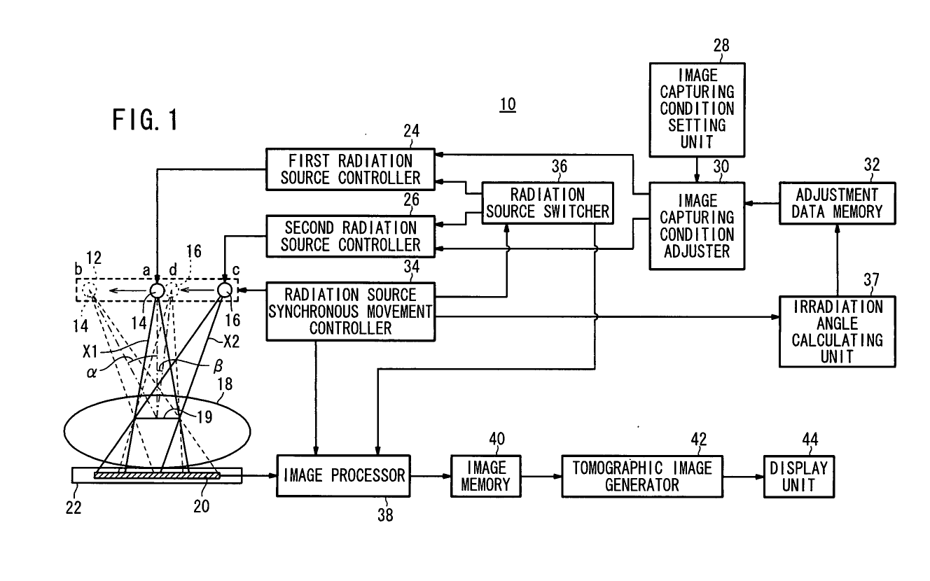

FIG. 1 schematically shows, partially in block form, a tomosynthesis apparatus 10, which serves as a tomographic image capturing apparatus according to a first embodiment of the present invention.

As shown in FIG. 1, the tomosynthesis apparatus 10 includes two radiation sources 14, 16, which can be moved by a moving mechanism 12 in the same directions, as indicated by the arrows, and a radiation detector 20 for detecting radiation X1, X2 emitted respectively from the radiation sources 14, 16 and which is transmitted through a subject 18 to be imaged, and for converting the detected radiation X1, X2 into respective items of radiographic image information. The tomosynthesis apparatus 10 generates a tomographic image of a region 19 of the subject 18 from the items of radiographic image information, when the radiation sources 14, 16 respectively apply radiation X1, X2 to the subject 18 while moving within respective ranges a to b and c to d above the subject 18. The radiation detector 20 is housed in an image capturing base 22, with the subject 18 being positioned on the image capturing base 22. For example, the radiation detector 20 may comprise a solid-state detector, such as an FPD (Flat Panel Detector), for converting the radiation X1, X2 into items of radiographic image information, which are electric signals.

The radiation sources 14, 16 are controlled respectively by a first radiation source controller 24 and a second radiation source controller 26, so as to emit radiation X1 and X2 respectively at predetermined doses. The first radiation source controller 24 and the second radiation source controller 26 control the radiation sources 14, 16 according to image capturing conditions, which are set by an image capturing condition setting unit 28 and adjusted by an image capturing condition adjuster (dose adjuster) 30. The image capturing conditions include tube voltages and tube currents that are supplied to the radiation sources 14, 16, and irradiation times for the radiation X1, X2. Doses of the radiation X1, X2 are determined by the products (mAs values) of the tube currents (mA) and the irradiation times (s).

An adjustment data memory 32 is connected to the image capturing condition adjuster 30. Adjustment data for adjusting the image capturing conditions that are set by the image capturing condition setting unit 28, according to irradiation angles of the radiation X1, X2 output from the radiation sources 14, 16 with respect to the radiation detector 20, are stored in the adjustment data memory 32. The adjustment data comprise data for adjusting image capturing conditions, in order to make constant the doses of radiation X1, X2 emitted from the respective radiation sources 14, 16 independently of the irradiation angles thereof. The adjustment data may be established as a coefficient for adjusting the mAs value of the radiation sources 14, 16. The adjustment data are determined as adjustment data for carrying out adjustment such that the doses of the emitted radiation X1, X2 which are measured with respect to their respective irradiation angles are made constant independently of the irradiation angles. The adjustment data are stored in the adjustment data memory 32.

The moving mechanism 12 is controlled by a radiation source synchronous movement controller 34 for moving the radiation sources 14, 16 synchronously in respective directions from positions a and c toward positions b and d. A radiation source switcher 36 is connected to the first radiation source controller 24 and the second radiation source controller 26. The radiation source switcher 36 controls the first radiation source controller 24 and the second radiation source controller 26 alternately, to turn on and off the radiation sources 14, 16 according to positional information of the radiation sources 14, 16, which is acquired from the radiation source synchronous movement controller 34. More specifically, the radiation source switcher 36 controls the first radiation source controller 24 and the second radiation source controller 26, so as to repeat a process of turning on one of the radiation sources 14, 16 to emit radiation X1 while turning off the other of the radiation sources 14, 16.

Further, respective positional information of the radiation sources 14, 16, which is acquired from the radiation source synchronous movement controller 34, is supplied to an irradiation angle calculating unit 37 (irradiation angle detector), in which irradiation angles α, β of the radiation sources 14, 16 with respect to the position information are calculated. The calculated irradiation angles α, β are supplied to the adjustment data memory 32.

An image processor 38 is connected to the radiation detector 20. The image processor 38 processes items of radiographic image information acquired from the radiation detector 20 when the radiation sources 14, 16 have moved to the respective positions b and d, according to switching signals for the radiation sources 14, 16, which are supplied from the radiation source switcher 36. The image processor 38 then stores the processed items of radiographic image information in an image memory 40. The items of radiographic image information, which have been stored in the image memory 40, are processed by a tomographic image generator 42 to generate a tomographic image of the region 19, which is displayed on a display unit 44.

The tomosynthesis apparatus 10 according to the first embodiment is basically constructed as described above. Operations of the tomosynthesis apparatus 10 according to the first embodiment will be described below.

First, image capturing conditions, including a tube voltage, a tube current, and irradiation times for the radiation X1, X2, which correspond to a region of the subject 18 to be imaged, are set using the image capturing condition setting unit 28. The image capturing conditions are set commonly for the radiation sources 14, 16. In the image capturing condition adjuster 30, the image capturing conditions that have been set are adjusted using the adjustment data stored in the adjustment data memory 32, in order to make the doses of radiation X1, X2 emitted from the radiation sources 14, 16 constant independently of the irradiation angle. For example, a coefficient for adjusting the mAs value that is set in the radiation sources 14, 16 is read from the adjustment data memory 32 as adjustment data for making the doses of the radiation X1, X2 emitted from the radiation sources 14, 16 constant independently of the irradiation angle, and the image capturing conditions are adjusted using the adjustment data.

The image capturing conditions set by the image capturing condition setting unit 28, and the image capturing conditions adjusted by the image capturing condition adjuster 30 are supplied to the first radiation source controller 24 and the second radiation source controller 26. Next, when a shot switch (not shown) is operated by a radiographic technician, the first radiation source controller 24 and the second radiation source controller 26 control the radiation sources 14, 16 according to the supplied image capturing conditions, whereby radiation X1, X2, which is adjusted to a constant dose, is emitted from each of the radiation sources 14, 16.

When the radiation sources 14, 16 initially begin to emit radiation X1, X2, the radiation sources 14, 16 are located in respective positions a and c. The radiation source synchronous movement controller 34 controls the moving mechanism 12 in order to move the radiation sources 14, 16 synchronously and in respective directions from the positions a and c, toward the positions b and d.

Positional information of the radiation sources 14, 16, as they are moved by the moving mechanism 12, is supplied from the radiation source synchronous movement controller 34 to the radiation source switcher 36. According to the supplied positional information, the radiation source switcher 36 controls the first radiation source controller 24 and the second radiation source controller 26 so as to selectively turn on and off the radiation sources 14, 16. More specifically, the radiation source switcher 36 causes the radiation X1, X2 emitted from either one of the radiation sources 14, 16 to be irradiated, by repeatedly carrying out a process in which, while one radiation source 14 is placed in an ON state, the other radiation source 16 is placed in an OFF state.

Further, the irradiation angle calculating unit 37 acquires positional information of the radiation sources 14, 16 from the radiation source synchronous movement controller 34, and calculates irradiation angles α, β of the radiation sources 14, 16 with respect to each of such positional information. The calculated irradiation angles α, β are supplied to the adjustment data memory 32, and adjustment data corresponding to each of the irradiation angles α, β are read out and supplied to the image capturing condition adjuster 30. The image capturing condition adjuster 30 supplies such adjustment data corresponding to the respective irradiation angles of the radiation sources 14, 16 to the first radiation source controller 24 and the second radiation source controller 26, for thereby adjusting the image capturing conditions. As a result, radiation X1, X2 having a constant dose not dependent on the irradiation angles is output from the radiation sources 14, 16.

Radiation X1, X2 applied to and transmitted through the subject 18 is detected respectively by the radiation detector 20, which converts the radiation X1, X2 into radiographic image information. The radiographic image information generated by the radiation detector 20 is supplied as radiographic image information, at respective positions of the radiation sources 14, 16, to the image processor 38. The radiographic image information then is stored in the image memory 40, according to positional information of the radiation sources 14, 16 supplied from the radiation source synchronous movement controller 34 and the switching signals, which are supplied from the radiation source switcher 36. In this case, the radiographic image information stored in the image memory 40 is acquired based on the radiation X1, X2 made up of a constant dose and without any influence of heel effect. Consequently, high quality radiographic image information devoid of shading caused by the irradiation angle can be obtained.

When the radiation sources 14, 16 have moved to their respective positions b and d, and all of the radiographic image information generated during movement of the radiation sources 14, 16 to the respective positions b and d has been stored in the image memory 40, one image capturing process is completed. The time required to move the radiation sources 14, 16 during the image capturing process is one-half of the time that would be required if one radiation source were moved from the position c to the position b at the same speed. Therefore, the time required to complete one image capturing process is reduced to one-half, although the acquired amount of radiographic image information remains the same. In other words, assuming that the time required to move the radiation sources 14, 16 during the image capturing process is the same as the time that would be required if only one radiation source were moved from the position c to the position b at the same speed, the acquired amount of radiographic image information is doubled. Accordingly, it is possible to produce a tomographic image having a high level of resolution.

Once the image capturing process is completed, the tomographic image generator 42 reads out and processes the radiographic image information stored in the image memory 40 in order to generate a tomographic image of the region 19 of the subject 18. The tomographic image generator 42 may generate a tomographic image according to a known process, such as a shift-and-add process or a filtered back projection (FBP) process. The generated tomographic image is displayed on the display unit 44 to enable interpretation thereof by a doctor for diagnostic purposes. In this case, since the tomographic image can be generated with high resolution based on a large number of items of radiographic image information devoid of shading, the tomographic image can be interpreted in detail and with high accuracy in order to perform a diagnosis.

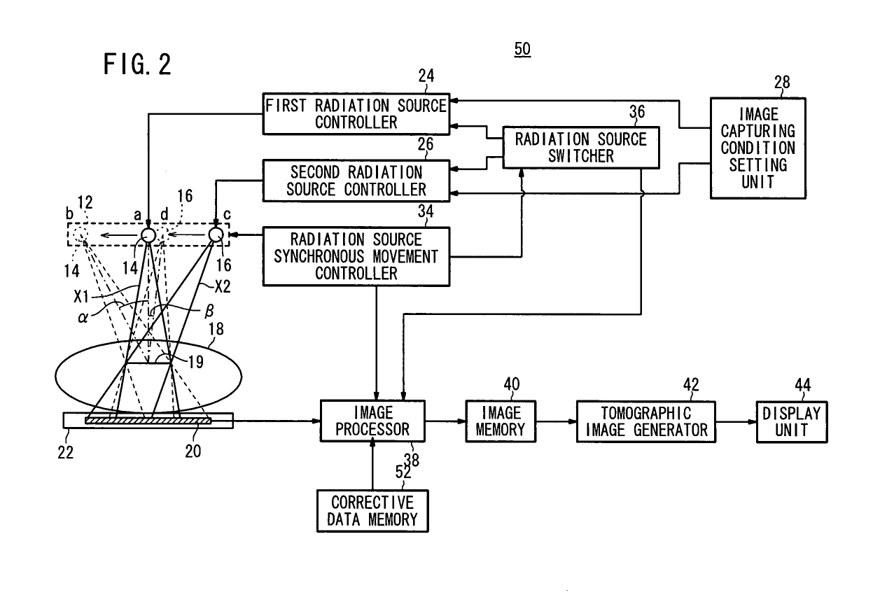

FIG. 2 shows schematically, and partially in block form, a tomosynthesis apparatus 50, which makes up a tomographic image capturing apparatus according to a second embodiment. Structural elements thereof, which are the same as those of the tomosynthesis apparatus 10 of the first embodiment, are designated by the same reference characters, and detailed discussion of such features shall be omitted.

The tomosynthesis apparatus 50 includes a corrective data memory 52 that stores corrective data for correcting the radiographic image information acquired from the radiation detector 20, into radiographic image information that should be acquired when the doses of radiation X1, X2 emitted from the radiation sources 14, 16 are kept constant.

The first radiation source controller 24 and the second radiation source controller 26 control the radiation sources 14, 16 in order to emit and apply radiation X1, X2 respectively to the subject 18 according to common image capturing conditions that are set by the image capturing condition setting unit 28. The image processor (image corrector) 38 corrects the radiographic image information, which is acquired from the radiation detector 20, with corrective data stored in the corrective data memory 52, whereby the radiographic image information is corrected to form radiographic image information at a time in which the doses of radiation X1, X2 emitted from the radiation sources 14, 16 are kept constant. The corrected radiographic image information then is stored in the image memory 40, and thereafter is processed by the tomographic image generator 42 to generate a tomographic image of the region 19, which is displayed on the display unit 44, so as to enable the tomographic image to be interpreted by a doctor for diagnosis.

The present invention is not limited to the aforementioned embodiments. It is a matter of course that various changes and modifications may be made to the embodiments without departing from the scope of the invention as set forth in the appended claims.

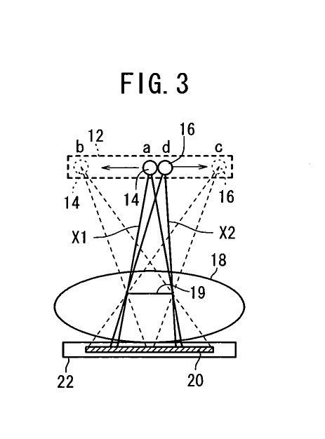

For example, although in the aforementioned tomosynthesis apparatus 10, 50, the radiation sources 14, 16 are moved in the same direction while image capturing is carried out, as shown in FIG. 3, the radiation sources 14, 16 may be arranged to begin moving away from each other synchronously from respective positions a and d which are proximate to each other, so as to separate respectively from one another in the directions indicated by the arrows, and thereafter, one image capturing process is completed when the radiation sources 14, 16 reach respective positions b and c. Since the radiation sources 14, 16 move away from each other synchronously in different directions, vibrations produced by movement of the radiation sources 14, 16 are canceled out. Consequently, the tomosynthesis apparatus is capable of acquiring radiographic image information more accurately and reliably.

Further, in each of the embodiments, although a configuration made up of two radiation sources 14, 16 is used to acquire radiation image information, the principles of the invention may also be applied similarly to a tomosynthesis apparatus having a structure in which only one radiation source is used. Furthermore, the invention can be applied to a tomosynthesis apparatus configured so that the radiation source and the radiation detector are moved relatively with respect to each other.

What is claimed is:

1. A tomographic image capturing apparatus comprising:
a radiation source movable along a predetermined path, for applying radiation to a subject at different angles;
a dose adjuster for adjusting the radiation source to make constant the dose of the radiation emitted from the radiation source independently of irradiation angles of the radiation with respect to the subject;
a radiation detector for detecting the radiation transmitted through the subject while the radiation source moves along the predetermined path, and converting the detected radiation into radiographic image information; and
a tomographic image generator for generating a tomographic image of the subject based on the radiographic image information converted from the radiation detected by the radiation detector.

2. A tomographic image capturing apparatus according to claim 1, further comprising:
an irradiation angle detector for detecting the irradiation angle of the radiation with respect to the subject; and
an adjustment data memory for storing adjustment data for adjusting the radiation source to make constant the dose of the radiation emitted from the radiation source based on the irradiation angle,
wherein the dose adjuster adjusts the radiation source based on the adjustment data.

3. A tomographic image capturing apparatus according to claim 1, wherein the radiation source comprises a plurality of radiation sources that apply radiation with respect to the subject at different times, and wherein the dose adjuster adjusts each of the radiation sources in order to make constant the doses of the radiation emitted therefrom.

4. A tomographic image capturing apparatus according to claim 1, wherein the tomographic image capturing apparatus comprises a tomosynthesis apparatus.

5. A tomographic image capturing apparatus comprising:
a radiation source movable along a predetermined path, for applying radiation to a subject at different angles;
a radiation detector for detecting the radiation transmitted through the subject while the radiation source moves along the predetermined path, and converting the detected radiation into radiographic image information;
an image corrector for correcting the radiographic image information into radiographic image information that should be acquired when the dose of the radiation emitted from the radiation source is made constant independently of irradiation angles of the radiation with respect to the subject; and
a tomographic image generator for generating a tomographic image of the subject based on the radiographic image information which has been corrected by the image corrector.

6. A tomographic image capturing apparatus according to claim 5, further comprising:
a correction data memory for storing corrective data for correcting the radiographic image information,
wherein the image corrector corrects the radiographic image information based on the corrective data.

7. A tomographic image capturing apparatus according to claim 5, wherein the radiation source comprises a plurality of radiation sources that apply radiation with respect to the subject at different times, and wherein the image corrector corrects the radiographic image information which has been acquired from each of the radiation sources.

8. A tomographic image capturing apparatus according to claim 5, wherein the tomographic image capturing apparatus comprises a tomosynthesis apparatus.
